(19) United States
(12) Patent Application Publication
(10) Pub. No.: US 2007/0195135 A1
(43) Pub. Date: Aug. 23, 2007

(54) METHOD OF MANUFACTURING COLOR FILTER USING INK-JET

(76) Inventors: Sang-il KIM, Suwon-si (KR); Sung-woong Kim, Suwon-si (KR); Wou-sik Kim, Suwon-si (KR); Kye-si Kwon, Seoul (KR); Sung-wook Kim, Suwon-si (KR)

Correspondence Address: STANZIONE & KIM, LLP, 919 18TH STREET, N.W., SUITE 440, WASHINGTON, DC, 20006, US

(21) Appl. No.: 11/566,939

(22) Filed: Dec. 5, 2006

(30) Foreign Application Priority Data
Feb. 20, 2006 (KR) 2006-16230

(51) Int. Cl. B41J 2/085

(52) U.S. Cl. 347/76

(57) ABSTRACT

A method of manufacturing a color filter using an ink-jet. In the method, a conversion voltage, which is obtained from a normalization voltage of each of the nozzles using a weight conversion factor corresponding to the number of nozzles turned on at the same time, is applied to each of the nozzles of an ink-jet head, and all regions of the color filter have the same ink thickness by using the weight conversion factor as a maximum value when the nozzles are all turned on, and by using a weight conversion factor smaller than the maximum value when not all of the nozzles are turned on at the same time.

### CROSS-REFERENCE TO RELATED APPLICATIONS

This application claims priority under 35 U.S.C. §119(a) from Korean Patent Application No. 10-2006-0016230, filed on Feb. 20, 2006, in the Korean Intellectual Property Office, the disclosure of which is incorporated herein in its entirety by reference.

### BACKGROUND OF THE INVENTION

1. Field of the Invention

The present general inventive concept relates to a method of manufacturing a color filter, and more particularly, to a method of manufacturing a color filter using an ink-jet.

2. Description of the Related Art

Flat panel display devices, such as liquid crystal displays (LCDs), plasma display panels (PDPs), organic electro luminescence (EL) panels, light emitting diode (LED) displays, and field emission displays (FEDs), have recently been used as large-sized screens for TVs and computers. In particular, LCDs are frequently used for computer monitors, notebooks computer screens, or the like.

The LCD includes a color filter to form a desired color image by filtering white light modulated by a liquid crystal layer. In the color filter, red (R), green (G), and blue (B) pixels are arranged on a transparent substrate in a specific pattern. The color filter may be manufactured by using a dyeing method, a pigment dispersion method, a printing method, or an electro-deposition method.

However, in the above methods, a certain process has to be repeated for each color so as to form the R, G, and B pixels, thereby resulting in poor efficiency in manufacture and increased manufacture costs.

Therefore, a method of manufacturing a color filter using an ink-jet has recently been proposed to simplify the manufacture process and reduce the manufacture costs. In this method, ink drops of specific colors (e.g. R, G, and B) are discharged through nozzles of an ink-jet head into each pixel region on a substrate, thereby forming a pixel of a specific color.

FIG. 1 illustrates a method of manufacturing a color filter by discharging ink into each pixel region of the color filter using a conventional ink-jet head. FIG. 2A is a graph illustrating a thickness of ink discharged into pixel regions by a first nozzle of the ink-jet head of FIG. 1, along a printing direction Y. FIG. 2B is a graph illustrating a thickness of ink discharged into pixel regions by a fourth nozzle of the ink-jet head of FIG. 1, along the printing direction Y. FIG. 3 illustrates regions of a color filter according to the ink thicknesses in FIGS. 2A and 2B.

Referring to FIG. 1, an ink-jet head 20 having a plurality of nozzles 21, 22, 23, and 24 respectively discharges ink into a plurality pixels regions 11 while passing above a color filter 10 in a printing direction corresponding to an arrow Y while being tilted by a predetermined angle with respect to the color filter 10. The ink-jet head 20 moves successively in a direction Y and then in a direction X while discharging ink into each of the pixel regions 11. After all the pixel regions 11 along a column in the Y direction are filled with ink, the ink-jet head 20 moves in the X direction, and then the ink-jet head discharges ink into each pixel region 11 along an adjacent column in the Y direction. The above processes are repeated until each of the pixel regions 11 of the color filter 10 is filled with ink.

Since the ink-jet head 20 moves while being tilted by the predetermined angle with respect to the color filter 10, the amount of ink discharged from each of the nozzles 21, 22, 23, and 24 varies in some regions where the ink-jet head 20 approaches or is separated from the color filter 10, depending on the number of nozzles discharging ink.

Referring to FIGS. 2A, 2B and 3, the amount of ink discharged from the first nozzle 21 gradually decreases in a region I along the direction Y, while in a region 11, the amount of discharged ink by the first nozzle 21 is constant along the direction Y as illustrated in FIG. 2A. On the other hand, the amount of ink discharged from the fourth nozzle 24 is constant in the region II along the direction Y, and gradually increases in a region III along the direction Y as illustrated in FIG. 2B.

This is because the number of the nozzles 21, 22, 23, and 24 that pass each of the regions of the color filter 10 varies when the ink-jet head 20 moves in the direction Y. In other words, although all of the four nozzles 21, 22, 23, and 24 discharge ink in the region 11, the number of ink discharging nozzles gradually increases or decreases as the second nozzle 22 to the fourth nozzle 24 sequentially approach the region I as the ink-jet head moves in the direction Y, or as the first nozzle 21 to the third nozzle 23 are sequentially separated from the region III as the ink-jet head moves in the direction Y,. Accordingly, in the regions I and III, the amount of ink discharged by each nozzle is greater than that in the region II.

This is due to the fact that cross-talk occurs between operating and non-operating nozzles among the nozzles 21, 22, 23, and 24. Thus, the amounts of ink discharged by each nozzle may differ depending on the number of adjacent nozzles operating at the same time.

The different amounts of ink discharged from the nozzles causes differences in the ink thickness of pixels. Thus, the ink thickness is non-uniform in some regions of the color filter 10, which results in poor reliability of a color reproduction rate.

### SUMMARY OF THE INVENTION

The present general inventive concept provides a method of manufacturing a color filter using an ink-jet, by which an ink thickness can be made uniform over all regions of the color filter by applying a conversion voltage corresponding to the number of nozzles operating at the same time to each nozzle.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing a method of manufacturing a color filter using an ink-jet, the method including moving an ink-jet head having a plurality of nozzles above the color filter while the color filter is being tilted by a predetermined angle, and discharging color ink into each of a plurality of pixel regions defined by a black matrix, wherein a conversion voltage, which is obtained from a normalization voltage of each of the nozzles using a weight conversion factor corresponding to the number of nozzles turned on at the same time, is applied to each of the nozzles, and wherein an ink thickness can be uniformly obtained over the entire regions of the color filter by using the weight conversion factor as a maximum value when the nozzles are all turned on, and by using a weight conversion factor smaller than the maximum value when not all of the nozzles are turned on at the same time.

The foregoing and/or other aspects and utilities of the present general inventive concept may also be achieved by providing a method of manufacturing a color filter using an ink-jet, the method including moving an ink-jet head having a plurality of nozzles above the color filter with the color filter while being tilted by a predetermined angle, and discharging color ink into each of a plurality of pixel regions defined by a black matrix, wherein, with respect to a plurality of regions of the color filter having a non-uniform ink thickness formed by applying a normalization voltage to each of the nozzles, an ink thickness can be uniformly obtained over the entire regions of the color filter by patterning a conversion voltage, which is obtained by using a voltage conversion factor used for discharging the amount of ink corresponding to a desired ink thickness of each of the nozzles, for each region and by applying the patterned voltage to each of the nozzles.

The foregoing and/or other aspects and utilities of the present general inventive concept may also be achieved by providing a method of manufacturing a color filter using an ink-jet head having a plurality of nozzles, the method including calculating a plurality of conversion voltages for each nozzle using a normalization voltage of each nozzle and a plurality of weight conversion factors, and applying the conversion voltage to the nozzle to discharge colored ink into a plurality of pixel regions defined in a black matrix, wherein the ink-jet head is tilted at an angle with respect to the black matrix, and wherein the conversion voltage is applied to each nozzle to eject ink while the ink-jet head sequentially moves over the black matrix in a first direction, such that all the pixel regions have a uniform ink thickness.

A number of nozzles that eject ink into the pixel regions may change as the ink-jet head moves in the first direction.

The weight conversion factor may correspond to the number of nozzles ejecting ink into the pixel regions as the ink-jet head moves in the first direction, and the normalization voltage may correspond to a voltage applied to each nozzle such that all nozzles eject the same amount of ink.

Different regions can be defined in the black matrix depending on the number of nozzles that eject ink into the pixel regions as the ink-jet head moves in the first direction, and the same weight conversion factor can be used for all the nozzles discharging ink into pixel regions for each different region of the black matrix.

The weight conversion factor for a region wherein all the nozzles discharge ink into the pixel regions as the ink-jet head moves in the first direction can be a maximum weight conversion factor and the weight conversion factor corresponding to regions where not all the nozzles are ejecting ink into the pixel regions as the ink-jet head moves in the first direction can be less than the maximum weight conversion factor.

The foregoing and/or other aspects and utilities of the present general inventive concept may also be achieved by providing a method of manufacturing a color filter using an ink-jet head having a plurality of nozzles which moves across the color filter, the method including determining a normalization voltage for each of the plurality of nozzles, determining a conversion weight factor for each nozzle for each of a plurality of pixel areas of the color filter, determining a conversion voltage for each nozzle for each pixel area using the normalization voltage and the conversion weight factor for that pixel area, and applying the conversion voltages to the nozzles as the ink-jet head sequentially moves in a first direction to eject colored ink into the plurality of pixel areas.

The conversion weight factor may correspond to a number of nozzles ejecting ink into each of the plurality of pixel areas as the ink-jet head moves in the first direction and the normalization voltage for each nozzle may correspond to a voltage applied to each nozzle such that all nozzles eject the same amount of ink.

A plurality of regions corresponding to groups of pixel areas can be defined on the color filter according to the number of nozzles discharging ink into pixel areas of that region.

The conversion weight factor may be the same for all nozzles ejecting ink into pixel areas within the same region.

The ink-jet head may be tilted at an angle with respect to the color filter.

The foregoing and/or other aspects and utilities of the present general inventive concept may also be achieved by providing a method of manufacturing a color filter using an ink-jet head having a plurality of nozzles, the method including defining a pattern of conversion voltages for each nozzle of the ink-head, and applying conversion voltages corresponding to the pattern to each nozzle as the ink-jet head sequentially moves in a first direction over the color filter defining a plurality of pixel areas to discharge colored ink into the pixel areas, wherein the conversion voltages are obtained from a normalization voltage of each nozzle and a weight conversion factor corresponding to each pixel area or a region comprising a plurality of pixel areas.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a conventional method of manufacturing a color filter by discharging ink into each pixel region of the color filter using a conventional ink-jet head;

FIG. 2A is a graph illustrating a thickness of ink discharged along a printing direction Y into pixel regions of the color filter of FIG. 1 by a first nozzle of the ink-jet head of FIG. 1;

FIG. 2B is a graph illustrating a thickness of ink discharged along the printing direction Y into pixel regions of the color filter of FIG. 1 by a fourth nozzle of the ink-jet head of FIG. 1,;

FIG. 3 illustrates regions according to the ink thicknesses of FIGS. 2A and 2B;

FIG. 4 illustrates an ink-jet head moving above a color filter according to an embodiment of the present general inventive concept;

FIG. 5 illustrates a weight conversion factor used to obtain a conversion voltage corresponding to each region of the color filter of FIG. 4, according to an embodiment of the present general inventive concept;

FIG. 6 is a graph illustrating a thickness of ink discharged into each pixel region of the color filter of FIG. 4 along a printing direction Y, using the conversion voltage obtained according to the weight conversion factor of FIG. 5;

FIG. 7 is a plan view illustrating separate regions of the color filter of FIG. 4, wherein different pattern voltages are applied to each of the regions according to another embodiment of the present general inventive concept;

FIG. 8A is a graph illustrating a normalization voltage corresponding to each nozzle of an ink-jet head according to an embodiment of the present general inventive concept;

FIG. 8B is a graph illustrating a voltage conversion factor corresponding to each nozzle according to an embodiment of the present general inventive concept;

FIG. 8C is a graph illustrating a conversion voltage obtained by multiplying the normalization voltage and the voltage conversion factor of FIGS. 8A and 8B; and

FIG. 9 is a graph illustrating a thickness of ink discharged along a printing direction Y into pixel regions of the color filter of FIG. 4 by using a pattern voltage.

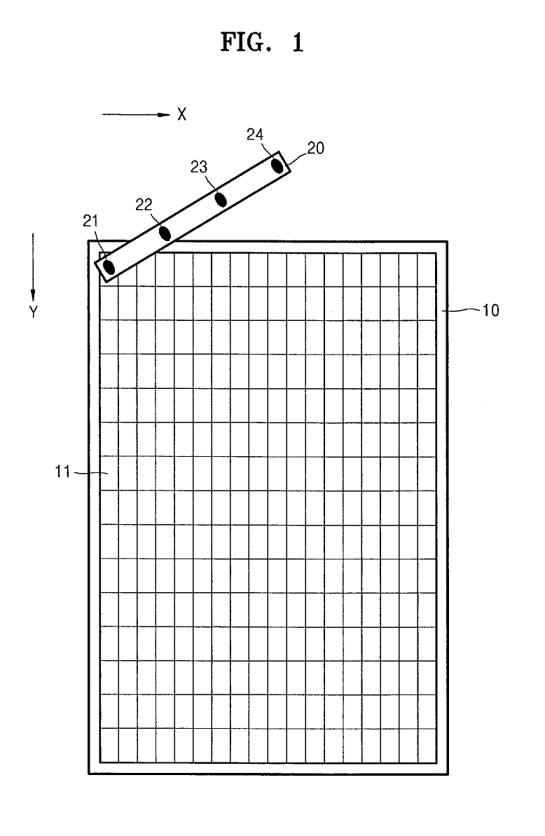

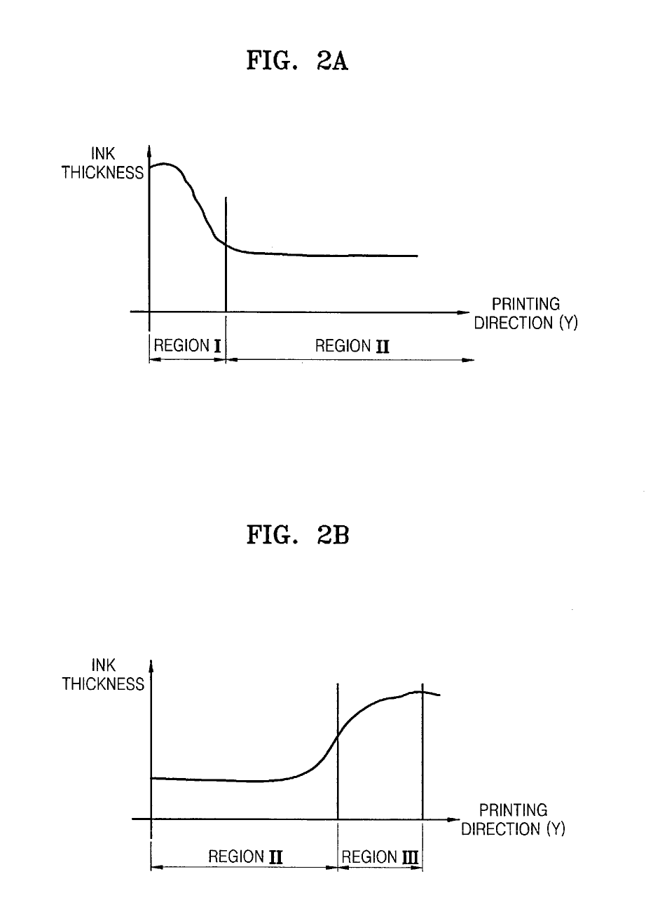

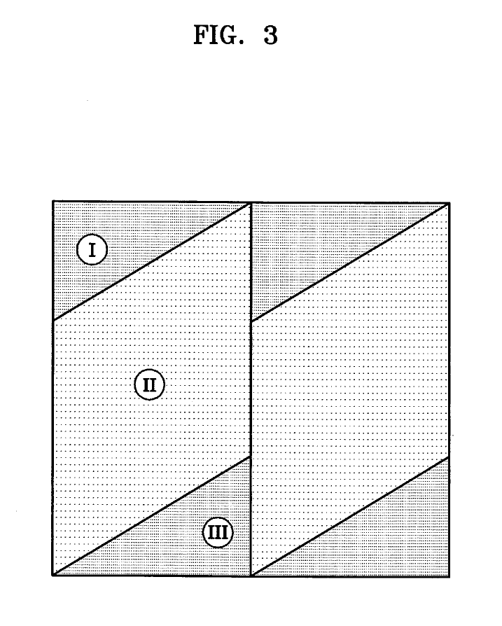

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

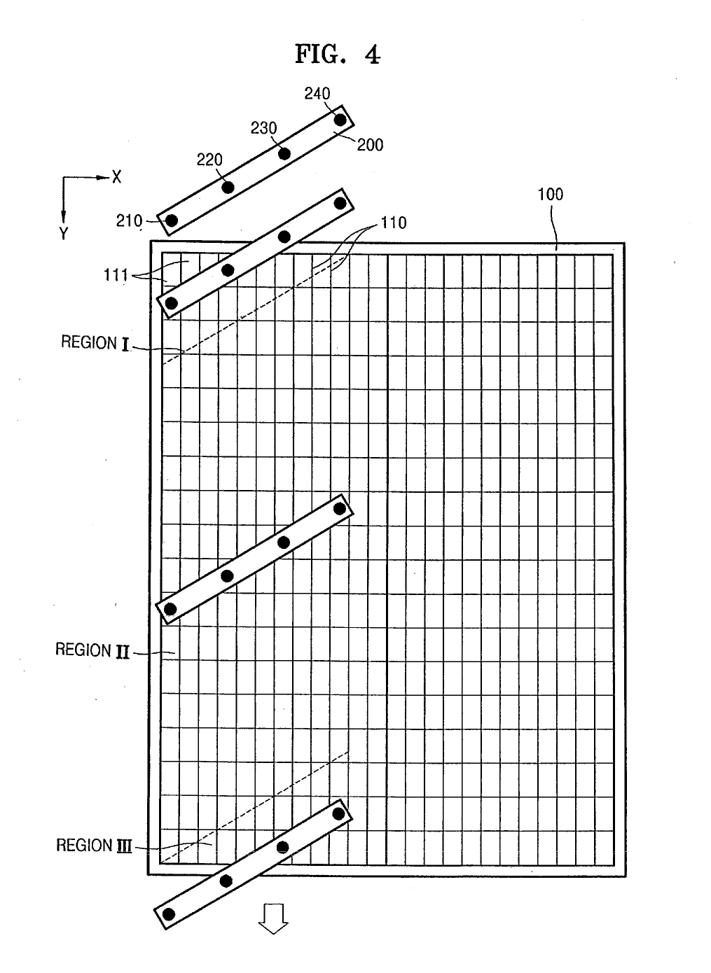

FIG. 4 illustrates an ink-jet head 200 moving above a color filter 100 according to an embodiment of the present general inventive concept.

Referring to FIG. 4, the color filter 100 includes a plurality of pixel regions 111 that are defined by a black matrix 110. The pixel regions 111 are sequentially filled with red, green, and blue colored ink to form color pixels.

The ink-jet head 200 includes four nozzles 210, 220, 230, and 240. While the ink-jet head 200 illustrated in FIG. 4 includes four nozzles, the present general inventive concept is not limited thereto, and the ink-jet head 200 may include a different number of nozzles. The ink-jet head 200 discharges ink into the pixel regions 111 while moving above the color filter 100 in a direction Y while being tilted by a predetermined angle with respect to the color filter 100.

When the ink-jet head 200 moves above the color filter 100 along the direction Y, since the ink-jet head 200 is tilted by the predetermined angle with respect to the color filter 100, the nozzles 210, 220, 230, and 240 are all turned on to discharge ink while passing above a region II of the color filter 100. Further, when the ink-jet head 200 is passing above a region I of the color filter 100, the number of nozzles turned on at the same time gradually increases as the ink-jet 200 moves along the direction Y and approaches the region II. Further, while the ink-jet head 200 is passing above a region III of the color filter 100, the number of nozzles above gradually decreases as the ink-jet head 200 continues to move along the direction Y.

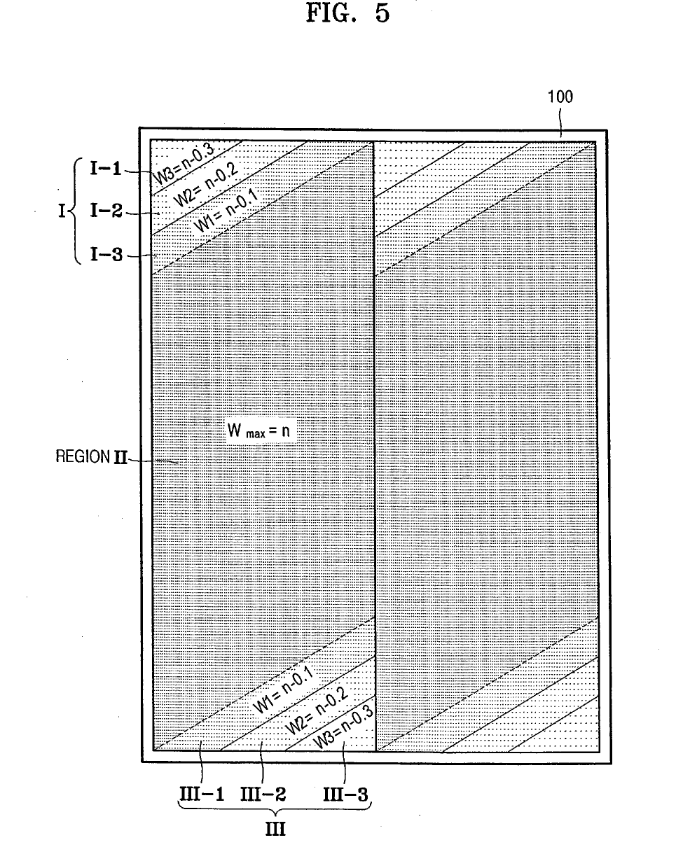

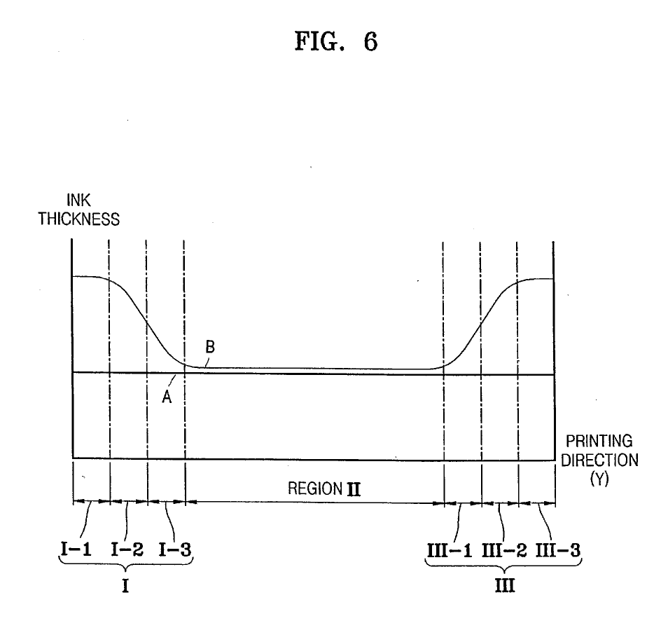

FIG. 5 illustrates a weight conversion factor used to obtain a conversion voltage corresponding to each region of the color filter 100 according to an embodiment of the present general inventive concept. FIG. 6 is a graph illustrating a thickness of ink discharged along a printing direction Y into pixel regions of the color filter 100 by using the conversion voltage obtained according to the weight conversion factor of FIG. 5.

According to an embodiment of the present general inventive concept, in order to equalize an ink thickness over the entire regions of the color filter 100, different conversion voltages Vr may be applied to each of the nozzles 210, 220, 230, and 240 according to the number of nozzles that are turned on at the same time in each region (regions I, II, and III) of the color filter 100.

Referring to FIG. 6, a curve B illustrates that each of the regions I, II, and III has different ink thickness along a printing direction Y, when ink is discharged by applying a normalization voltage Vn to each of the nozzles 210, 220, 230, and 240.

The normalization voltage Vn is defined as a voltage that is experimentally obtained to be applied to each of the nozzles 210, 220, 230, and 240 so as to discharge the same amount of ink from the nozzles 210, 220, 230, and 240. Thus, when the normalization voltage Vn is applied to each of the nozzles 210, 220, 230, and 240, the same amount of ink is discharged from the nozzles 210, 220, 230, and 240.

In general, after the ink-jet head 200 having the nozzles 210, 220, 230, and 240 is manufactured, even if ink is discharged by applying the same voltage to each of the nozzles 210, 220, 230, and 240, the amounts of ink discharged from the nozzles 210, 220, 230, and 240 may differ from one another. When the ink is discharged into the color filter 100 in this state, the ink thickness of the color filter 100 becomes non-uniform. In order to prevent this problem, the normalization voltage Vn can be applied to each of the nozzles 210, 220, 230, and 240.

However, although the normalization voltage Vn is applied to each of the nozzles 210, 220, 230, and 240 as described above, the amounts of ink discharged from each of the nozzles 210, 220, 230, and 240 may still differ according to the number of nozzles turned on at the same time, as indicated by the curve B in FIG. 6.

As a result, the ink thickness may be thinner in the region II than in the regions I and III. To obtain a uniform ink thickness over the entire regions I, II, and III of the color filter 100, the amount of ink discharged into the region 11 may have to be maximized, and the amount of ink discharged into the regions I and III may have to be less than the maximum amount of ink discharged in region II. Thus, a desired uniform ink thickness can be obtained as indicated by a thick line A in FIG. 6.

The amount of ink can be regulated by controlling a magnitude of the conversion voltage Vr applied to each of the nozzles 210, 220, 230, and 240. This can be achieved by obtaining the conversion voltage Vr by multiplying the normalization voltage Vn and a weight conversion factor W corresponding to each of the regions I, II, and III.

Referring to FIG. 5, the weight conversion factor W is defined as a relative value based on the amount of ink discharged from each of the nozzles 210, 220, 230, and 240 according to the number of nozzles turned on at the same time.

The region I of the color filter 100 can be divided into sub-regions I-1,I-2, and I-3 along a direction Y in which the ink-jet head 200 moves, as illustrated in FIG. 5.

In the sub-region I-1, only the first nozzle 210 may be turned on as the ink-jet head 200 moves in the Y direction. Similarly, in the sub-region I-2, the first nozzle 210 and the second nozzle 220 may be turned on at the same time, and in the sub-region I-3, the first nozzle 210, the second nozzle 220, and the third nozzle 230 may be turned on at the same time as the ink-jet head 200 continues to move in the Y direction.

When the ink-jet head 200 moves from the sub-region I-1 to the sub-region I-3, the weight conversion factor W for the nozzles turned on at the same time in each of the sub-regions I-1, I-2, and I-3 may increase. In this case, the weight conversion factor W used for each of the sub-regions I-1, I-2, and I-3 may be less than a weight conversion factor Wmax of the region II.

For example, the weigh conversion factor W used for each of the sub-regions I-1, I-2, and I-3 may gradually increase such that when the weight conversion factor Wmax used for the region II is n, a weight conversion factor W3 used for the sub-region I-1 is n-0.3, a weight conversion factor W2 used for the sub-region I-2 is n-0.2, and a weight conversion factor W1 used for the sub-region I-3 is n-01. In this case, if n is 1, W1 is 0.9, W2 is 0.8, and W3 is 0.7.

That is, the conversion voltage Vr applied to each of the nozzles 210, 220, 230, and 240 gradually increases according to the number of nozzles turned on at the same time while the ink-jet head 200 moves from the sub-region I-1 to the sub-region I-3.

The region III of the color filter 100 may also be divided into sub-regions III-1, III-2, and III-3 along the direction Y of the ink-jet head 200 as illustrated in FIG. 5.

In the sub-region III-1, the second nozzle 220, the third nozzle 230, and the fourth nozzle 240 may be turned on at the same time as the ink-jet head 200 moves in the X direction. Similarly, in the sub-region III-2, the third nozzle 230 and the fourth nozzle 240 may be turned on at the same time and in the sub-region III-3, only the fourth nozzle 240 may be turned on as the ink-jet head 200 moves in the X direction.

When the ink-jet head 200 moves in the Y direction from the sub-region III-1 to the sub-region III-3, the weight conversion factor W for the nozzles turned on at the same time in each of the sub-regions III-1, III-2, and III-3 may gradually decrease. In this case, the weight conversion factor W used for each of the sub-regions III-1, III-2, and III-3 may be less than the weight conversion factor Wmax of the region II.

For example, the weigh conversion factor W used for each sub-regions III-1, III-2, and III-3 may gradually decrease such that when the weight conversion factor Wmax used for the region II is n, a weight conversion factor W1 used for the sub-region III-1 is n-0.1, a weight conversion factor W2 used for the sub-region III-2 is n-0.2, and a weight conversion factor W3 used for the sub-region III-3 is n-0.3. In this case, if n is 1, W1 is 0.9, W2 is 0.8, and W3 is 0.7.

The variable n is used so that an absolute value of the conversion voltage Vr can be increased by using the variable n. For example, if n=2, the conversion voltage Vr becomes twice as much as the conversion voltage Vr when n=1.

Referring to FIG. 6, the ink thickness of the pixel regions 111 obtained from the conversion voltage Vr by using the weight conversion factor W for each of the nozzles 210, 220, 230, and 240 in each region according to an embodiment of the present general inventive concept is uniform along the printing direction Y of the ink-jet head 200, as illustrated by solid line A in FIG. 6.

The same weight conversion factor W may be used for the sub-regions I-1 and III-3, the sub-regions I-2 and III-2, and the sub-regions I-3 and III-1 of FIG. 5. This is because the number of nozzles turned on at the same time may be the same in each pair of sub-regions.

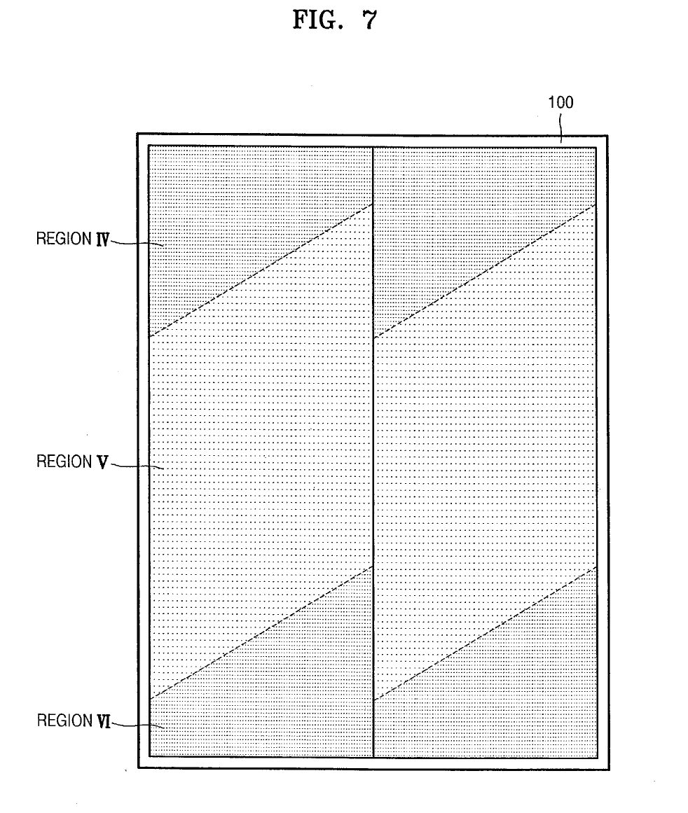

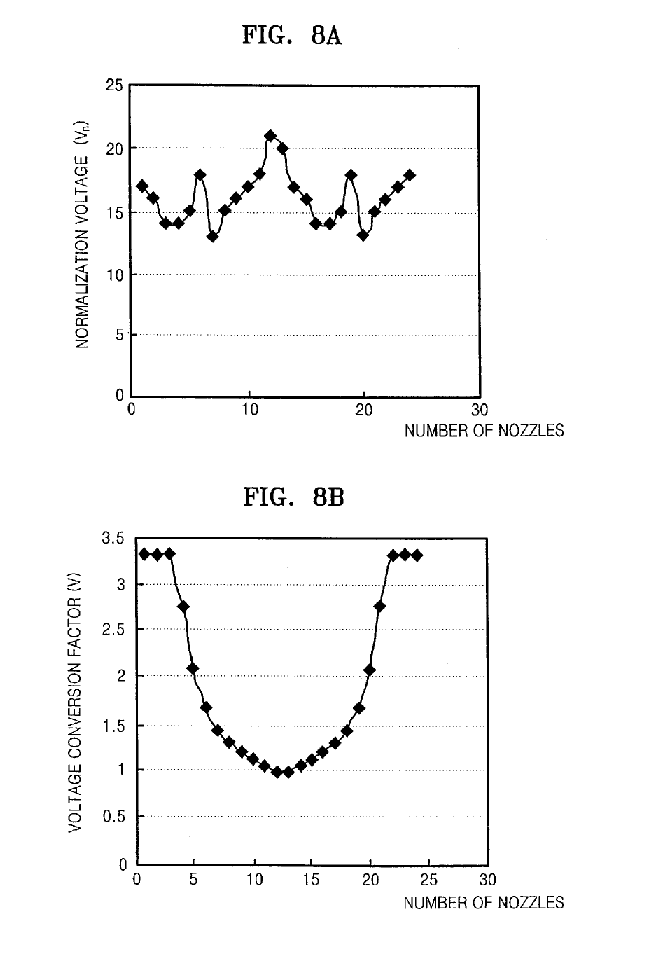

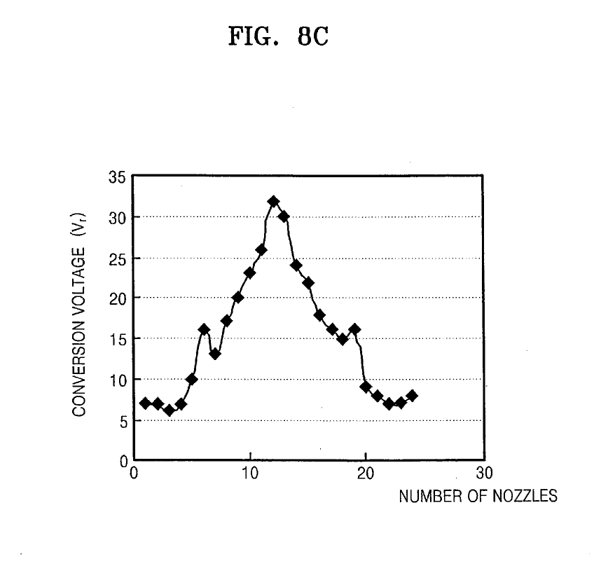

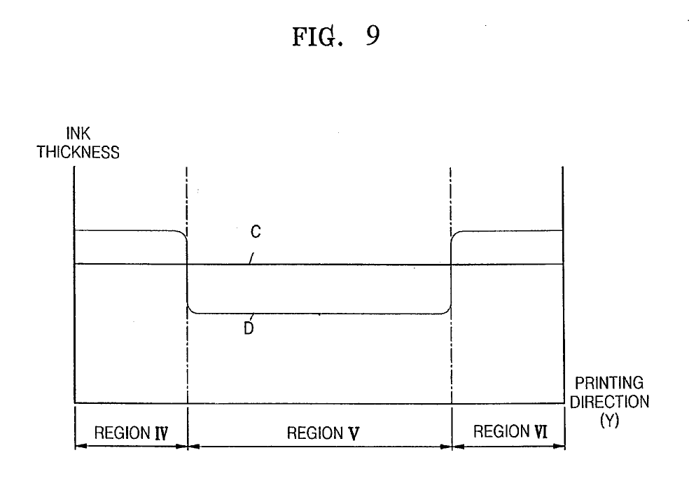

FIG. 7 is a plan view illustrating separate regions of the color filter 100, wherein different pattern voltages Vp are applied to the separate regions according to another embodiment of the present general inventive concept. FIG. 8A is a graph illustrating a normalization voltage Vn corresponding to each nozzle. FIG. 8B is a graph illustrating a voltage conversion factor V corresponding to each nozzle. FIG. 8C is a graph illustrating a conversion voltage Vr obtained by multiplying the normalization voltage Vn and the voltage conversion factor V of FIGS. 8A and 8B. FIG. 9 is a graph illustrating a thickness of ink discharged along a printing direction into pixel regions 111 of the color filter 100 by using a pattern voltage Vp.

According to another embodiment of the present general inventive concept, in order to obtain a constant ink thickness in all regions of the color filter 100, a voltage based on the amount of discharged ink corresponding to the desired ink thickness can be experimentally obtained from the nozzles 210, 220, 230, and 240, and a pattern voltage Vp, which is patterned into a voltage table to match the voltage experimentally obtained, may be applied to the nozzles 210, 220, 230, and 240. Therefore, all regions of the color filter 100 may have the same ink thickness.

To achieve this, the normalization voltage Vn is applied to each of the nozzles 210, 220, 230, and 240 as the ink-jet head 200 sequentially moves in the Y and X directions, and then a thickness of ink discharged into each of the pixel regions 111 s estimated over all the regions of the color filter 100. The normalization voltage Vn has already been described above, and thus, detailed descriptions thereof will be omitted.

Referring to FIG. 7, a plurality of regions (regions IV, V, and VI) having non-uniform ink thicknesses may exist in the color filer 100 after ink is discharged into each of the pixel regions 111 using the normalization voltage Vn. For example, if the ink thickness is thin in the regions IV and VI, and the ink thickness is thick in the region V, a voltage applied to each of the nozzles 210, 220, 230, and 240 has to be regulated so that the regions IV, V, and VI can have the same ink thickness.

The above mentioned regions IV, V, and VI are explained only as an example, and thus the present general inventive concept is not limited thereto, and various non-uniform regions may be formed in the color filter 100. There are many reasons why non-uniform regions IV, V, and VI exist even if the normalization voltage Vn is respectively applied to the nozzles 210, 220, 230, and 240. However, regardless of what the reason may be, a regulated voltage may have to be applied to each of the nozzles 210, 220, 230, and 240 so that the ink thickness can be made constant in all regions of the color filter 100.

Therefore, an obtained voltage conversion factor V corresponds to the amount of ink to be respectively discharged from the nozzles 210, 220, 230, and 240 when the ink-jet head passes above the regions IV, V, and VI so as to make the regions of the color filter 100 have the same ink thickness.

The voltage conversion factor V can be experimentally obtained. Since a voltage for equalizing the amount of ink respectively discharged from the nozzles 210, 220, 230, and 240 has the same value as the conversion voltage Vr experimentally obtained for each of the nozzles 210, 220, 230, and 240, the voltage conversion factor V can be obtained as a variable for converting the normalization voltage Vn into the conversion voltage Vr.

Thus, the conversion voltage Vr corresponding to the desired ink thickness can be obtained from the normalization voltage Vn by using the voltage conversion factor V. The conversion voltage Vr that has to be applied to the each of the nozzles 210, 220, 230, and 240 at each position where the nozzles 210, 220, 230, and 240 sequentially pass above the regions IV, V, and VI are obtained to form a table for each of the regions IV, V, and VI, thereby obtaining the pattern voltage Vp.

The pattern voltage Vp included in the table for each of the regions IV, V, and VI is sequentially applied when the ink-jet head 200 sequentially passes above each of the regions IV, V, and VI, so that the nozzles 210, 220, 230, and 240 discharge the same amount of ink in response to the applied pattern voltage Vp.

By applying the pattern voltage Vp for each of the regions IV, V, and VI, the amount of ink discharged from each of the nozzles 210, 220, 230, and 240 can be easily regulated. Thus, the ink thickness can be uniformly obtained in a rapid manner in all regions of the color filter 100 by applying the pattern voltage Vp.

Referring to FIGS. 8A to 8C, the conversion voltage Vr of FIG. 8C corresponding to each of the nozzles 210, 220, 230, and 240 can be obtained by adding the normalization voltage Vn of FIG. 8A corresponding to each of the nozzles 210, 220, 230, and 240 and the voltage conversion valve V of FIG. 8B corresponding to each of the nozzles 210, 220, 230, and 240.

According to the above mentioned method, the conversion voltage Vr that has to be applied whenever the nozzles 210, 220, 230, and 240 pass above a specific position is listed in a table to obtain the pattern voltage Vp.

Referring to FIG. 9, the same ink thickness as indicated by a thick line C can be obtained in all the regions of the color filter 100 by applying the pattern voltage Vp corresponding to each of the regions IV, V, and VI according to another embodiment of the present general inventive concept.

A curved line D of FIG. 9 indicates another case of obtaining a non-uniform ink thickness for each of the regions IV, V, and VI by discharging ink using the normalization voltage Vn for each of the nozzles 210, 220, 230, and 240.

As described above, the method of manufacturing a color filter using an ink-jet according to the present general inventive concept may have the following advantages.

First, the same ink thickness can be obtained in all regions of the color filter by regulating a voltage applied to each nozzle of ink-jet head in an easy manner.

Second, the same ink thickness can be obtained in all regions of the color filter by applying a pattern voltage corresponding to each region of the color filter in an easy and rapid manner.

Third, since all the regions of the color filter have the same ink thickness, the brightness of light passing through the color filter can be more uniform.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of manufacturing a color filter using an ink-jet, the method comprising:
moving an ink-jet head having a plurality of nozzles above the color filter, the ink-jet being tilted with respect to the color filter by a predetermined angle; and
discharging color ink into each of a plurality of pixel regions defined by a black matrix on the color filter,
wherein a conversion voltage, which is obtained from a normalization voltage of each of the nozzles using a weight conversion factor corresponding to the number of nozzles turned on at the same time, is applied to each of the nozzles, and
wherein all regions of the color filter have the same ink thickness by using the weight conversion factor as a maximum value when the nozzles are all turned on, and by using a weight conversion factor smaller than the maximum value when not all of the nozzles are turned on at the same time.

2. The method of claim 1, wherein, a first region is defined as a region where the nozzles are all turned on, a second region is defined as a region where the nozzles are sequentially turned on, and a third region is defined as a region where the nozzles are sequentially turned off, and the weight conversion value corresponding to the number of nozzles turned on at the same time gradually increases in the second region, and the weight conversion value corresponding to the number of nozzles turned off at the same time gradually decreases in the third region.

3. The method of claim 2, wherein the weight conversion value corresponding to the number of nozzles turned on at the same time is the same in the second and third regions.

4. A method of manufacturing a color filter using an ink-jet, the method comprising:
moving an ink-jet head having a plurality of nozzles above the color filter, the ink-jet head being tilted with respect to the color filter; and
discharging color ink into each of a plurality of pixel regions defined by a black matrix on the color filter,
wherein, with respect to a plurality of regions of the color filter having a non-uniform ink thickness formed by applying a normalization voltage to each of the nozzles, an ink thickness can be uniformly obtained over the entire regions of the color filter by patterning a conversion voltage, which is obtained by using a voltage conversion factor used for discharging the amount of ink corresponding to a desired ink thickness of each of the nozzles, for each region and by applying the patterned voltage to each of the nozzles.

5. The method of claim 4, wherein the conversion voltage is obtained from the normalization voltage by using the voltage conversion factor.

6. A method of manufacturing a color filter using an ink-jet head having a plurality of nozzles, the method comprising:
calculating a plurality of conversion voltages for each nozzle using a normalization voltage of each nozzle and a plurality of weight conversion factors; and
applying the conversion voltage to the nozzle to discharge colored ink into a plurality of pixel regions defined in a black matrix,
wherein the ink-jet head is tilted at an angle with respect to the black matrix, and
wherein the conversion voltage is applied to each nozzle to eject ink while the ink-jet head sequentially moves over the black matrix in a first and second direction, such that all the pixel regions have a uniform ink thickness.

7. The method of claim 6, wherein a number of nozzles that eject ink into the pixel regions changes as the ink-jet head moves in the first direction.

8. The method of claim 7, wherein:
the weight conversion factor corresponds to the number of nozzles ejecting ink into the pixel regions as the ink-jet head moves in the first direction, and
the normalization voltage corresponds to a voltage applied to each nozzle such that all nozzles eject the same amount of ink.

9. The method of claim 7, wherein different regions are defined in the black matrix depending on the number of nozzles that eject ink into the pixel regions as the ink-jet head moves in the first direction, and the same weight conversion factor is used for all the nozzles discharging ink into pixel regions for each different region of the black matrix.

10. The method of claim 9, wherein the weight conversion factor for a region wherein all the nozzles discharge ink into the pixel regions as the ink-jet head moves in the first direction is a maximum weight conversion factor and the weight conversion factor corresponding to regions where not all the nozzles are ejecting ink into the pixel regions as the ink-jet head moves in the first direction is less than the maximum weight conversion factor.

11. A method of manufacturing a color filter using an ink-jet head having a plurality of nozzles which moves across the color filter, the method comprising:
determining a normalization voltage for each of the plurality of nozzles;
determining a conversion weight factor for each nozzle for each of a plurality of pixel areas of the color filter;
determining a conversion voltage for each nozzle for each pixel area using the normalization voltage and the conversion weight factor for that pixel area; and
applying the conversion voltages to the nozzles as the ink-jet head sequentially moves in a first direction to eject colored ink into the plurality of pixel areas.

12. The method of claim 11, wherein the conversion weight factor corresponds to a number of nozzles ejecting ink into each of the plurality of pixel areas as the ink-jet head moves in the first direction and the normalization voltage for each nozzle corresponds to a voltage applied to each nozzle such that all nozzles eject the same amount of ink.

13. The method of claim 12, wherein a plurality of regions corresponding to groups of pixel areas is defined on the color filter according to the number of nozzles discharging ink into pixel areas of that region.

14. The method of claim 13, wherein the conversion weight factor is the same for all nozzles ejecting ink into pixel areas within the same region.

15. The method of claim 11, wherein the ink-jet head is tilted at an angle with respect to the color filter.

16. A method of manufacturing a color filter using an ink-jet head having a plurality of nozzles, the method comprising:
defining a pattern of conversion voltages for each nozzle of the ink-head; and
applying conversion voltages corresponding to the pattern to each nozzle as the ink-jet head sequentially moves in a first direction over the color filter defining a plurality of pixel areas to discharge colored ink into the pixel areas,
wherein the conversion voltages are obtained from a normalization voltage of each nozzle and a weight conversion factor corresponding to each pixel area or a region comprising a plurality of pixel areas.

17. The method of claim 16, wherein the conversion weight factor corresponds to a number of nozzles ejecting ink into each of the plurality of pixel areas as the ink-jet head moves in the first direction.
